(19) United States
(12) Patent Application Publication
(10) Pub. No.: US 2026/0066832 A1
(43) Pub. Date: Mar. 5, 2026

(54) COMPRESSOR MODULE, COMPRESSED-AIR SUPPLY SYSTEM, AND METHOD FOR OPERATING A COMPRESSED-AIR SUPPLY SYSTEM HAVING THE COMPRESSOR MODULE

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/379,608

(22) Filed: Nov. 4, 2025

Related U.S. Application Data
(63) Continuation of application No. PCT/EP2024/061314, filed on Apr. 24, 2024.

(30) Foreign Application Priority Data
May 9, 2023 (DE) 10 2023 112 173.1

(51) Int. Cl. H02P 29/032; B60G 11/27; B60G 17/052; B60T 13/26; B60T 13/68; B60T 17/02; F15B 15/18; G05D 16/20

(52) U.S. Cl. CPC H02P 29/032; B60G 11/27; B60T 13/268; B60T 13/683; B60T 17/02; F15B 15/18; G05D 16/2066; B60G 17/0523; B60G 2202/152; B60G 2202/412; B60G 2202/42

(57) ABSTRACT

A compressor module has a compressor and a speed-controlled brushless electric motor for driving the compressor. A motor current is produced during operation of the electric motor. The electric motor is assigned a motor electronics system with an electronic commutator and a speed controller. The compressor module is connected to or has an electronic control unit. The control unit is configured to specify, depending on the mean motor current, one of at least two different target speeds for the electric motor, specifically at least a predefined first target speed and a predefined second target speed, which is lower than the predefined first target speed, and to change over from specifying the predefined first target speed to specifying the predefined second target speed when the mean motor current reaches or exceeds a specified motor current limit value. The compressor module can be for a compressed-air supply system of a vehicle.

### CROSS-REFERENCE TO RELATED APPLICATIONS

This application is a continuation application of international patent application PCT/EP2024/061314, filed Apr. 24, 2024 designating the United States and claiming priority from German application 10 2023 112 173.1, filed May 9, 2023, and the entire content of both applications is incorporated herein by reference.

### TECHNICAL FIELD

The disclosure relates to a compressor module, in particular a compressor module for a compressed-air supply system of a vehicle. The disclosure also relates to a compressed-air supply system for a motor vehicle including the compressor module, and also to a method for operating the compressed-air supply system including the compressor module and a speed-controlled electric motor for driving the compressor.

### BACKGROUND

Compressor modules are used, for example, for compressed-air supply systems of motor vehicles. In motor vehicles, compressed-air supply systems can supply compressed air to, for example, an air spring system with air springs as compressed-air consumers and/or a pneumatic brake system with compressed-air brakes as compressed-air consumers. In order to be able to supply compressed air at a sufficiently high pressure for compressed-air consumers of this kind, compressing devices or compressors are required for generating compressed air. Compressing devices or compressors of this kind are typically driven by electric motors. Compressing devices or compressors are used as synonyms in the present description and refer to assemblies which compress air.

Electric motors used for driving compressing devices are preferably brushless direct-current motors (BLDC motors: brushless direct-current motors). A brushless direct-current motor, as a so-called internal rotor motor, typically has a stator fitted with electromagnetic coils—that is, to a coil-wound stator—, a rotor fitted with permanent magnets, and a motor electronics system. The motor electronics system is configured as an electronic commutator in such a way that the motor electronics system controls the current supply to the coils of the stator (also referred to as stator coils below) via circuit breakers such that the stator coils are in turn periodically supplied with current in such a way that a rotating magnetic field is produced, this causing synchronous rotation of the rotor fitted with permanent magnets due to magnetic forces. Brushless direct-current motors of this kind with rotors fitted with permanent magnets are therefore also referred to as PMSM motors, where PMSM stands for permanent magnet synchronous motor. The abbreviation PMSM is typically used for sine-commutated brushless electric motors, while the abbreviation BLDC (brushless direct-current) is usually used for block-commutated brushless electric motors. In block commutation, the energization of the (for example three or n times three) stator coils is digitally switched over, that is, either no current or full current is applied to the windings of the respective stator coil or stator coils of a phase. In sine commutation, each stator coil of the motor is energized with a sine curve offset by 120°, this resulting in a continuously rotating stator magnetic field of constant strength.

For speed control known per se of a brushless electric motor, the electric motor has means for rotor angle detection which have electronic sensors, such as Hall sensors for example, for detecting the rotor position. This also allows a phase angle between the applied rotating field and the mechanical rotation of the rotor to be detected and the phase angle of the rotating field to be correspondingly adjusted. BLDC motors therefore behave similarly to mechanically commutated direct-current motors. However, brushless direct-current motors are more efficient and subject to less wear and their speed can be controlled better than electric motors with a brush commutator.

In compressor modules for generating compressed air in a compressed-air supply system, for example for motor vehicles, the compressor generating the compressed air and its electric motor serving as a drive form one structural unit. For both efficient and environmentally friendly operation, the configuration and operation of the electric motor—that is, the brushless direct-current motor-pose a particular challenge. This involves, inter alia, the compressor module having to provide a sufficient amount of compressed air even under unfavorable conditions that occur only rarely (worst-case operating situation). For this purpose, the drive, that is, the brushless direct-current motor, also has to be configured in a corresponding manner. At a given supply voltage of the brushless direct-current motor, a higher mechanical load—that is, a higher mechanical output power-inevitably leads to a greater current consumption by the brushless direct-current motor. However, in order to protect the on-board electrical system of a motor vehicle, the maximum current consumption by a brushless direct-current motor has to be limited.

WO 2020/225024 A1 discloses operating a BLDC motor for driving a compressor at a constant speed and reducing this speed depending on the load conditions operating voltage and load (torque) in order to avoid overdimensioning the motor.

### SUMMARY

It is an object of the disclosure to ensure reliable and environmentally friendly operation of a compressor module in the simplest possible way.

The disclosure discloses various compressor modules. The compressor module can be for a compressed-air supply system of a vehicle. According to an embodiment, a compressor module has a compressor and a speed-controlled brushless electric motor for driving the compressor, a motor current IB being produced during operation of the electric motor. The speed-controlled brushless electric motor is assigned a motor electronics system with an electronic commutator and a speed controller. According to the disclosure, the compressor module is connected to or has an electronic control unit, wherein the electronic control unit is configured:
to specify, depending on the mean motor current I_{B}, one of at least two different target speeds for the electric motor, specifically at least a predefined first target speed n_{1, soll} and a predefined second target speed n_{2, soll}, which is lower than the predefined first target speed n_{1, soll}, and,
to change over from specifying the predefined first target speed n_{1, soll} to specifying the predefined second target speed n_{2, soll} when the mean motor current I_{B} reaches or exceeds a, in particular a first, specified motor current limit value Iₘₐₓ.

The criterion for reducing the speed is preferably not the instantaneous value of the motor current, but rather a mean motor current, which represents the short-term average value of the motor current, so that a reduction in speed is not already triggered by a short-term current peak or cyclical fluctuations in the instantaneous value of the motor current.

The disclosure proposes configuring the motor not only as standard for at least two constant speeds as a function of the operating voltage and torque requirement (which corresponds to the air pressure to be generated), but rather for, preferably additively, introducing a functional target current specification or limiting as an alternative, advantageous control variable. In this case, suitable, voltage-dependent current limiting, which can also be specified by the vehicle, can protect the on-board electrical system and provide situation-dependent overload protection. The result is a superimposed, current-dependent target speed specification taking into account the current limits that apply in each case.

Specifying a lower predefined second target speed in the case in which the mean motor current reaches or exceeds a specified motor current limit value, for example the first motor current limit value, effectively reduces the delivered power and thus also effectively reduces the mean motor current received by the brushless electric motor, and thus effectively prevents overloading of the brushless electric motor and/or the on-board electrical system by simple means because this solution makes use of the motor electronics system with an electronic commutator and a speed controller present in a brushless electric motor in any case, and over and above this requires only very little expenditure on control, which can be easily achieved by simple means. At the lower predefined second target speed, the brushless electric motor of the compressor module can deliver a higher torque required in special load cases, without the specified motor current limit value being exceeded.

The proposed solution offers the advantage that the measured variable for the limit value-specifically the specified motor current limit value-which triggers specification of a lower predefined second target speed is easy to detect. This allows the electronic control unit to be simple and robust with respect to controlling the compressor module. The measure to be taken when the limit value is reached—specifically specification of a lower predefined second target speed—is also simple and can be implemented, in particular, without any expenditure because motor electronics of the brushless electric motor that are present in any case can be used for this purpose.

Another positive effect is that frequent changes in speed of the brushless electric motor are avoided and therefore the compressor module can also be acoustically optimized for a few speed ranges.

The disclosure encompasses the finding that one disadvantage of the speed specification is that the requirement of a constant target speed n (n=const) results in a motor current that increases with the load torque, which in individual cases can also exceed the defined maximum limit for the received motor current I_{B} of, for example, 35 A. Specifying a target speed for the speed controller based on the mean motor current has the advantage of assembly-specific tolerances, different temperatures and other values that influence the motor current not having to be stored in the form of worst-case assumptions, but rather can be detected independently of the specific assembly and the changes in the specified speed can thus be reduced to the minimum necessary extent.

The proposed solution is simpler than the known solution of configuring the electric motor as standard for at least two constant speeds depending on the operating voltage and torque requirement (the torque requirement depends on the level of pressure that the compressor is intended to generate). In this case, specifying at least one current limit value for the mean motor current as a criterion for the transition from a higher first to a lower predefined second target speed in addition to the known solution can be provided as alternative, advantageous load-dependent control.

More than two target speeds are preferably specified and the control unit is preferably configured to change over from specifying a predefined higher target speed (n_{x, soll}) to specifying a predefined lower target speed (n_{x+1, soll}) when the mean motor current (I_{B}) reaches or exceeds the or a corresponding specified motor current limit value (Iₘₐₓ; I_{max, red}). This variant has the advantage that the reduction in the target speed and thus also the reduction in the power delivered by the compressor module can take place in smaller steps, so that the jumps in speed and power are not too large. According to one configuration variant, exactly one motor current limit value is specified. If this is achieved for the first time in a load case, the target speed is reduced from the predefined first target speed to the lower predefined second target speed. If, during operation at the lower predefined second target speed, the load—and thus the torque to be output there—is intended to increase to such an extent that the specified (first and only) motor current limit value is reached again, the target speed can be further reduced from the second specified target speed to an even lower, third specified target speed. Depending on the extent of the respective reduction in target speed, several specified target speeds can thus be specified.

The compressor module can preferably be configured such that it can be supplied with different supply voltages, wherein the control unit is configured to apply different predefined motor current limit values (Iₘₐₓ; I_{max, red}) for the different supply voltages. It is particularly advantageous here if the control unit is configured to apply motor current limit values I_{max, red}, which are lower than a predefined maximum motor current limit value Iₘₐₓ, for supply voltages U_{V}, the respective voltage values of which lie below a limit voltage value U_{V grenz}. For example, the compressor module can be configured such that it can be supplied with at least two supply voltages of different levels. The control unit is then designed to specify predefined motor current limit values for each of the at least two different supply voltages in such a way that the motor current limit values predefined for the at least two different supply voltages are different from each other.

The maximum motor current limit value can preferably be adjusted to one of at least two different maximum motor current limit values.

The electric motor preferably has:
an electrically commutable stator,
a permanently excited rotor, and
   the motor electronics system
preferably forms a speed-controlled electronic commutator, which generates an electrical rotating field for the electric motor in accordance with a specified target speed nₛₒₗₗ.

The compressor module can preferably have a current sensor for detecting the current I_{B} received by the electric motor, and an analog-to-digital converter for converting an output value delivered by the current sensor into a digital signal representing the mean motor current I_{B} received by the electric motor. The current sensors used may be the current sensors of the motor electronics system that are usually provided for each phase. A mean motor current can already be formed by the motor electronics system on the compressor module or by the compressed-air controller. For example, the motor electronics system can determine the mean motor current from the three measured phase currents. As an alternative, an additional current sensor could also be provided.

The mean motor current is a value of the motor current averaged over a period of a few seconds and/or low-pass filtered. Forming a short-term average value of the motor current or low-pass filtering the motor current prevents short-term peak values of the motor current from already leading to a reduction in speed. For the purpose of transmitting the value of the motor current, the compressor module has an interface via which the digital signal representing the motor current received by the electric motor can be called up during operation. A value for the mean motor current can already be formed in the compressor module.

In addition, it is advantageous if the electric motor is configured such that it can deliver a maximum expected torque down to a supply voltage of 11.5 V without the specified motor current limit value being exceeded. In this way, unnecessarily frequent switchover to a lower target speed can be avoided.

A further aspect of the disclosure relates to a compressed-air supply system according to various embodiments of the disclosure. According to an embodiment, a compressed-air supply system for a motor vehicle has:
a compressor module,
at least one compressed-air consumer, in particular of an air spring system or a brake system,
a compressed-air reservoir
controllable valves and
a compressed-air control unit for controlling the valves.

The compressed-air supply system is preferably constructed in such a way that it can be switched over between open operation and closed operation.

A further aspect of the disclosure relates to a method according to various embodiments of the disclosure. According to an embodiment, a method for operating a compressed-air supply system having a compressor and a speed-controlled electric motor for driving the compressor includes:
specifying a predefined first target speed,
regularly or continuously comparing a respectively current value of the mean motor current with a predefined maximum motor current limit value, and
specifying a predefined second target speed, which is lower than the predefined first target speed, as soon as a respectively current value of the mean motor current is greater than or equal to the predefined maximum motor current limit value.

Concepts of the disclosure is not restricted to a compressed-air supply system or a compressed-air consumer of a vehicle, such as air springs of an air spring system or compressed-air brakes of a brake system, including a compressing device for generating compressed air, using a controlled brushless electric motor. Rather, the method on which the disclosure is based serves as a general method for operating controlled brushless electric motors in various load ranges at constant speeds.

### BRIEF DESCRIPTION OF DRAWINGS

The invention will now be described with reference to the drawings wherein:

FIG. 1 shows a compressor module including a compressor, an electric motor and a motor electronics system;

FIG. 2 shows a circuit diagram of an example of a compressed-air supply system together with a compressed-air consumer in the form of air springs of a vehicle;

FIGS. 3A and 3B show symbols for the valves shown in FIG. 2 for explaining their manner of operation;

FIG. 4 shows a sketch for illustrating the manner of operation of a brushless electric motor;

FIG. 5 shows a symbolic representation of a compressor and a brushless electric motor driving it and including a motor electronics system;

FIG. 6 shows a graph for illustrating the switchover, known from the prior art, from a specified higher target speed to an assigned lower target speed as a function of the operating voltage and load;

FIG. 7A shows a graph for illustrating the switchover according to the disclosure from a specified higher target speed to an assigned lower target speed when a specified motor current limit value is reached;

FIG. 7B shows a graph for illustrating a variant of the switchover according to the disclosure from a specified higher target speed to an assigned lower target speed when a specified motor current limit value is reached;

FIG. 8 shows a graph for illustrating a further variant of the switchover according to the disclosure from a specified higher target speed to an assigned lower target speed when a specified motor current limit value is reached;

FIGS. 9A and 9B show a graph for illustrating a further variant of the switchover according to the disclosure from a specified higher target speed to an assigned lower target speed when a specified motor current limit value is reached; and,

FIG. 10 shows a graph for illustrating a further variant of the switchover according to the disclosure from a specified higher target speed to an assigned lower target speed when a specified motor current limit value is reached.

### DETAILED DESCRIPTION

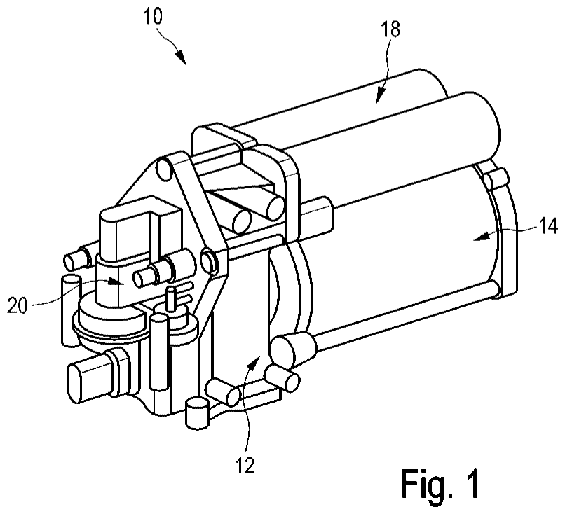

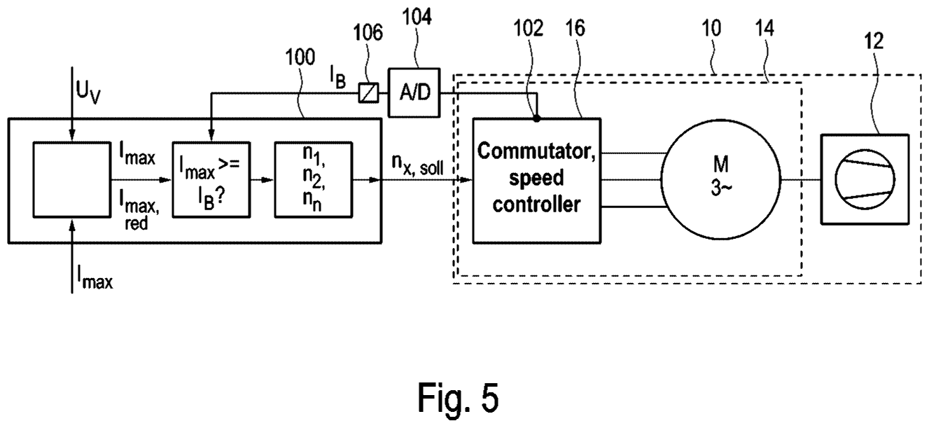

A compressor module 10 can be configured as a structural unit consisting of compressor 12, electric motor 14 and motor electronics system (16, see FIG. 5; not shown in FIG. 1; typically directly flange-connected to the electric motor 14) and also further components, such as air dryer 18 and air distributor 20, et cetera, for example, see FIG. 1.

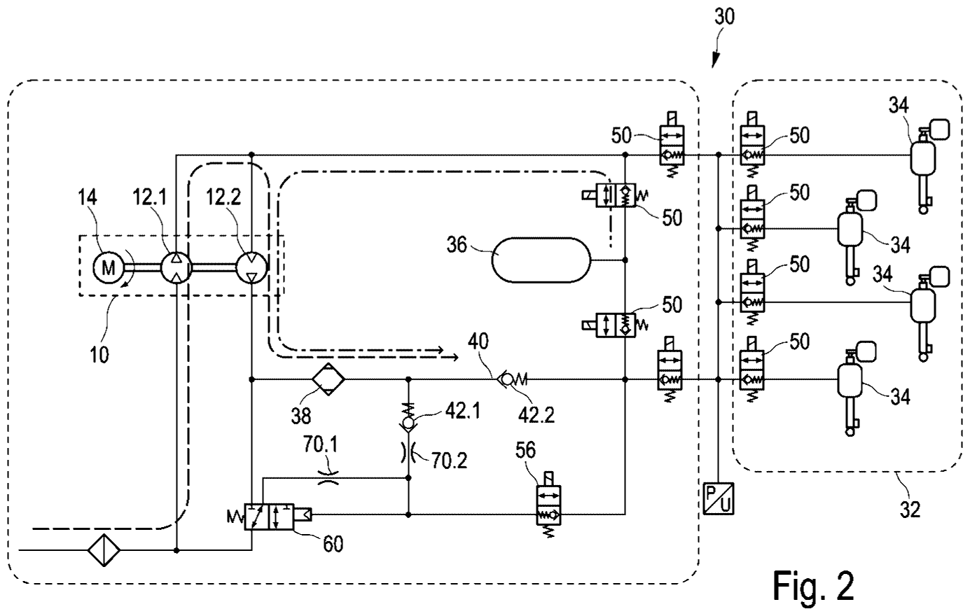

The compressor module 10 is provided for use in a compressed-air supply system 30, as illustrated by way of example in FIG. 2 with reference to a circuit diagram. The compressed-air supply system 30 is used, for example, to supply compressed air to an air spring system 32 including a plurality of air springs 34 of a vehicle. Instead of an air spring system, other compressed-air consumers, for example compressed-air brakes of a compressed-air brake system, can also be pneumatically connected to the compressed-air supply system 30.

The compressed-air supply system 30 shown in FIG. 2 can be operated during open operation or during closed operation. During open operation, outside air is drawn in from the surrounding area and compressed (see the dashed arrow in FIG. 2), and during closed operation, air is extracted from a pressure vessel 36—also referred to as a reservoir here—and compressed (see the dash-dotted arrow in FIG. 2). During open operation, the outside air is thus, in two stages, first pre-compressed via the compressor 12.1 and then re-compressed via the compressor 12.2. Since the air in the pressure vessel 36 is already at a higher static pressure than the outside air in the surrounding area, the air is re-compressed only via the compressor 14.2 during closed operation.

In both cases, the compressed air is finally supplied to and through a one-way or non-return valve 42.2 via an air dryer 38 of a pneumatic main pressure line 40 and thus provided for delivery to an air spring system 34 or supplied to the pressure vessel 36.

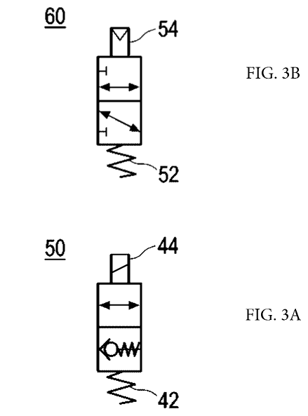

The delivery of the compressed air to the air spring system 32 or the compressed-air vessel 36 and also the distribution of the compressed air within the air spring system 32—in the case of the example between the air springs 34 of the air spring system 32—are performed via electrically actuated 2/2-way valves 50, one of which is also shown in FIG. 3A. In their first (rest) position caused via a return spring 42, the 2/2-way valves 50 act as a one-way or non-return valve. In the actuated second (working) position, the 2/2-way valves 50 are opened. The electrically actuable 2/2-way valves 50 are connected to an electronic control unit, not shown, which can be identical to an electronic control unit for controlling the compressor module 10 and can actuate control solenoids 54 of the 2/2-way valves 50.

Venting of the compressed-air supply system 30 and the spring system 32 can be caused by opening a ventilation valve 56, which is also configured as an electrically actuated 2/2-way valve. Opening the ventilation valve 56 causes a pneumatically controlled 3/2-way valve 60, as is also shown in FIG. 3B, to be moved to the working position. The working position is the position in which venting is performed. The pressure of the air to be vented acts here as a control pressure, which acts on a control piston 54, which moves the 3/2-way valve 60 against the force of its return spring 52 to the working position. Throttles 70.1 and 70.2 and also a further non-return or one-way valve 42.2 provide expedient limiting of the control pressure for actuating the pneumatically controlled 3/2-way valve 60.

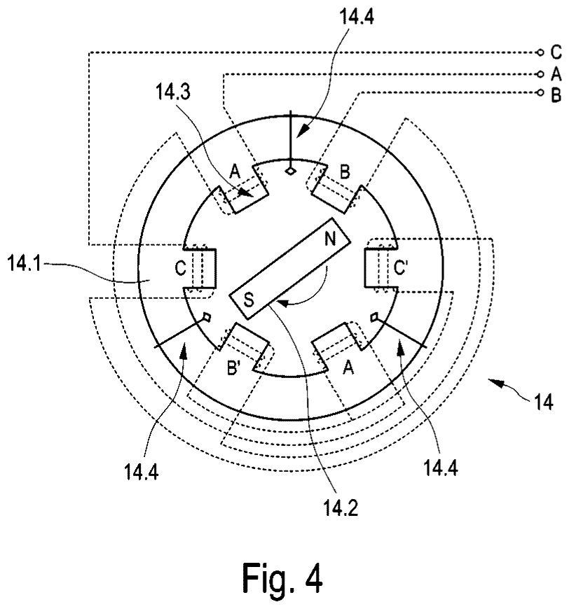

FIG. 4 shows a sketch of the stator and rotor of a brushless direct-current motor. The sketched brushless direct-current motor 14, as a so-called internal rotor motor, typically has a stator 14.1 fitted with electromagnetic coils, that is, a coil-wound stator, a rotor 14.2 fitted with permanent magnets, and a motor electronics system 16 (see FIG. 5). The motor electronics system 16 is configured as an electronic commutator in such a way that the motor electronics system 16 controls the current supply to the stator coils 14.3 of the stator 14.1 via circuit breakers and the connections A, B and C such that the stator coils 14.3 are in turn periodically supplied with current in such a way that a rotating magnetic field is produced, this causing synchronous rotation of the rotor 14.2 fitted with permanent magnets due to magnetic forces.

For speed control known per se of the brushless electric motor 14, the electric motor has means for rotor angle detection, for example a Hall sensor 14.4, for detecting the rotor position. This also allows a phase angle between the applied rotating field and the mechanical rotation of the rotor 14.2 to be detected and the phase angle of the rotating field to be correspondingly adjusted. The BLDC motor 14 therefore behaves similarly to a mechanically commutated direct-current motor. However, as a brushless direct-current motor, it is more efficient and subject to less wear and its speed can be controlled better than electric motors with a brush commutator.

In order to generate the rotating field by periodically energizing the stator coils 14.3 via the terminals A, B and C, the motor electronics system 16 is provided, which acts as an electronic commutator; see FIG. 5.

The speed of the electric motor 14 is also controlled in a manner known per se via the motor electronics system 16. For this purpose, a target speed is specified for the motor electronics system 16. In order to specify the target speed, an electronic control unit 100 is provided, which is supplied a value for the mean motor current by the motor electronics system 16 or which is connected to a current sensor 102, which detects the respective motor current received by the electric motor 12 during operation.

The current consumption by the electric motor 12 can be both calculated from the measured phase currents by the motor electronics system 16 and directly measured via a current sensor. In the first case, three current sensors of the motor electronics system are required, which are necessary for operational safety in any case. The variant without a separate current sensor is therefore preferred.

The electronic control unit 100 is configured in such a way that, depending on the mean motor current I_{B}, one of at least two different target speeds for the electric motor 14, specifically at least a predefined first target speed n_{1, soll} and a predefined second target speed n_{2, soll}, which is lower than the predefined first target speed n_{1, soll}, is determined and/or specified, and a changeover is made from specifying the predefined first target speed n_{1, soll} to specifying the predefined second target speed n_{2, soll} when the mean motor current I_{B} reaches or exceeds a specified motor current limit value Iₘₐₓ or I_{max, red}.

The compressor module 10 has at least one current sensor 102 for detecting the motor current IB received by the electric motor 14, and an analog-to-digital converter 104 for converting an output value delivered by the current sensor 104 into a digital signal representing the mean motor current I_{B} received by the electric motor 14. The digital signal representing the motor current received by the electric motor can be called up during operation via an interface 106. The motor current I_{B} represented by the digital signal is preferably already a time-averaged or low-pass-filtered motor current.

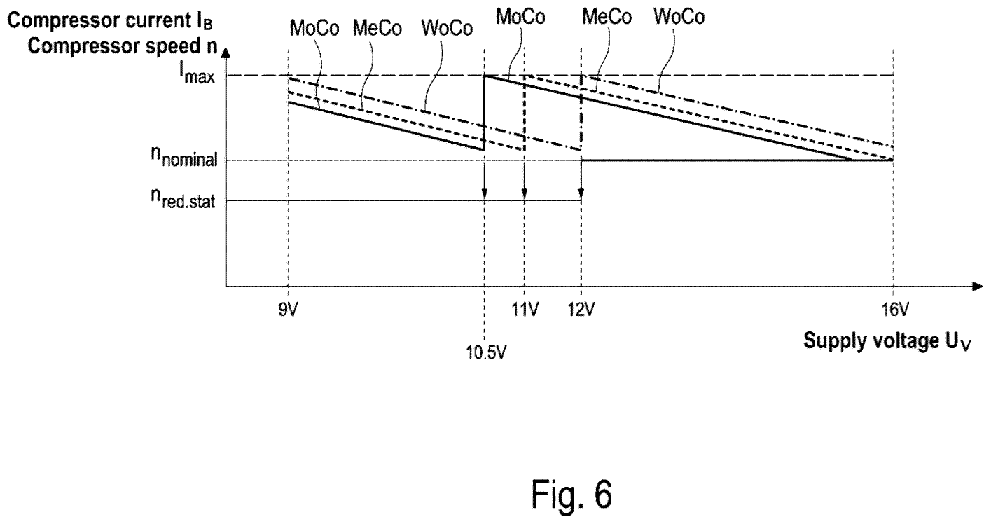

FIG. 6 illustrates the changeover from a specified higher target speed nₙₒₘᵢₙₐₗ to an assigned lower target speed n_{red, stat} when a specified supply voltage U is undershot, as is known from WO 2020/225024 A1.

In the prior art, switchover to the lower target speed takes place even before the maximum permissible motor current is reached, depending on the efficiency of the respective electric motor. If, for example, a changeover is already made at a supply voltage of 12 V, the least efficient electric motor is already at the maximum permissible motor current, while more efficient electric motors receive a significantly lower motor current at this supply voltage and load.

Specifically, FIG. 6 shows that a “worst efficient compressor” WoCo would exhibit the maximum permissible current consumption at a supply voltage<=12 V; a reduction in speed would therefore be required at 12 V. A “mean efficient compressor” MeCo would exhibit the maximum permissible current consumption at a supply voltage<=11 V; a reduction in speed would therefore be required at 11 V. A “most efficient compressor” MoCo would exhibit the maximum permissible current consumption at a supply voltage<=10.5V; a reduction in speed would therefore be required at 10.5 V.

The solution proposed in WO 2020/225024 A1 requires switchover to the lower speed depending on the load and supply voltage, so that a “worst efficient compressor” cannot exceed the maximum motor current. All “better” compressors thus switch to the second lower speed earlier than necessary, which leads to an avoidable reduction in the compressor performance in the vehicle.

If the nominal conditions are temporarily exceeded or the customer demands lower maximum currents depending on the situation, the approach from WO 2020/225024 A1 alone is not sufficient either.

In general, the requirement for constant compressor speed with a decreasing compressor supply voltage U or with increasing mechanical load (compressing device drive torque M) leads to an increasing compressor current because the mechanical power of the compressor module and the received electrical power are related as follows:

$$M \times 2 π \times n = η \times U \times I$$

where:
M=compressing device drive torque (=constant at constant pressure)
n=compressing device speed (=constantly specified and controlled)
η=motor efficiency
U=supply voltage (variable from 9 V to 16 V as required)
I=motor current

The supply voltage is the voltage of the on-board electrical system and is typically 9 V to 16 V. The maximum permissible motor current is limited to, for example, 35 A by specification requirements.

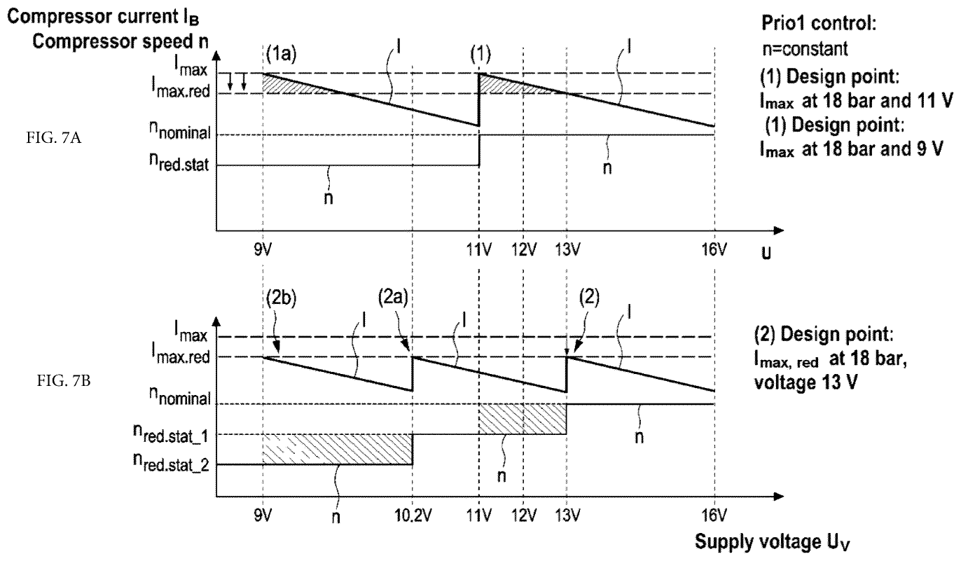

The upper graph in FIG. 7A shows the current I rising as the voltage U drops. In the example, the current I reaches the limit Iₘₐₓ at a voltage of 11 V (point (1)), the compressor speed n constantly corresponds to the first target speed nₙₒₘᵢₙₐₗ, corresponding to n_{1, soll}. The solution known from WO 2020/225024 A1 provides for reduction to a second, reduced speed n_{2, soll} (also referred to as n_{red, stat}) at the supply voltage of 11 V (point 1). If the operating voltage U drops further, the current consumption of the electric motor, which is initially reduced by the reduction in speed, increases again. At 9 V, Iₘₐₓ is then reached again (point 1a).

In this prior art, the voltage limit for the reduction in speed is statically defined by parametrization, in the example at 11 V, and applies equally to all operating conditions and compressors.

During switchover according to the disclosure as a function of a specified motor current limit value, the operating voltage at which switchover to the lower target speed is made is variable.

FIG. 7A and FIG. 7B show how a motor current limit value can be expediently specified and what effects this has on the operating behavior of the electric motor.

FIG. 7A shows a first case, in which the established current value Iₘₐₓ is greater than the limit value specified by the user due to, for example, scatter, rare operating conditions, et cetera. In this case, Iₘₐₓ is the current established at the current operating conditions for the compressor currently in use, and Iₘₐₓ, red is the maximum current statically permissible by the user. The hatched regions indicate operating states which would then violate the permissible current consumption according to the user's specifications.

FIG. 7A shows a first case, in which the user demands a low limit value I_{max, red}, which can also be dynamically specified, depending on the situation or else specifically for a specific vehicle.

In this case, compliance with the defined current limit is ensured by implementing further target speeds, in the lower example the speeds n_{red, stat_1} and n_{red, stat_2}. According to the embodiment shown in FIG. 7B, three speed ranges are thus defined, and therefore two switchover voltages are produced.

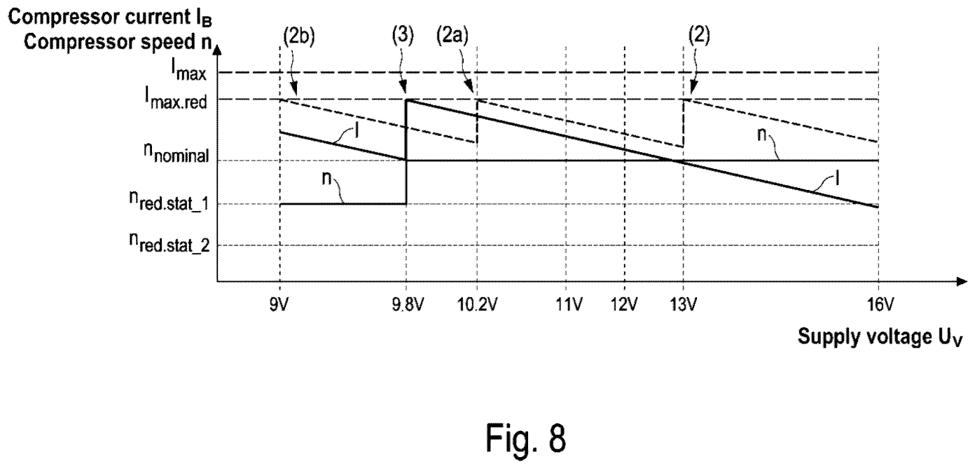

However, since switchover is not performed as a function of a specified (switchover) voltage, but rather as a function of the mean motor current, the electric motor can be operated significantly more efficiently. If, for example, the power consumption of the compressing device (and thus the necessary motor current) drops due to operation at a height of 3000 m, the approach allows the first target speed of nₙₒₘᵢₙₐₗ to be maintained down to significantly lower operating voltages. In the example in FIG. 8, the current consumption during operation at a height of 3000 m is shown by a solid line. Using the current limit I_{max, red}, a single reduction in speed at 9.8 V is sufficient to not exceed the maximum current.

FIG. 8 also illustrates, with reference to the dashed sawtooth line, how corresponding target speeds and associated jumps in speed can be provided in order to reduce the adaptive speed selection. For example, the first target speed nₙₒₘᵢₙₐₗ (n_{1, soll}) can be 3000 rpm, the reduced second target speed n_{red, stat_1} (n_{2, soll}) can be 2800 rpm, the further reduced third target speed n_{red, stat_2} (n_{3, soll}) can be 2600 rpm and an even further reduced fourth target speed n_{red, stat_3} (n_{4, soll}) can be 2400 rpm.

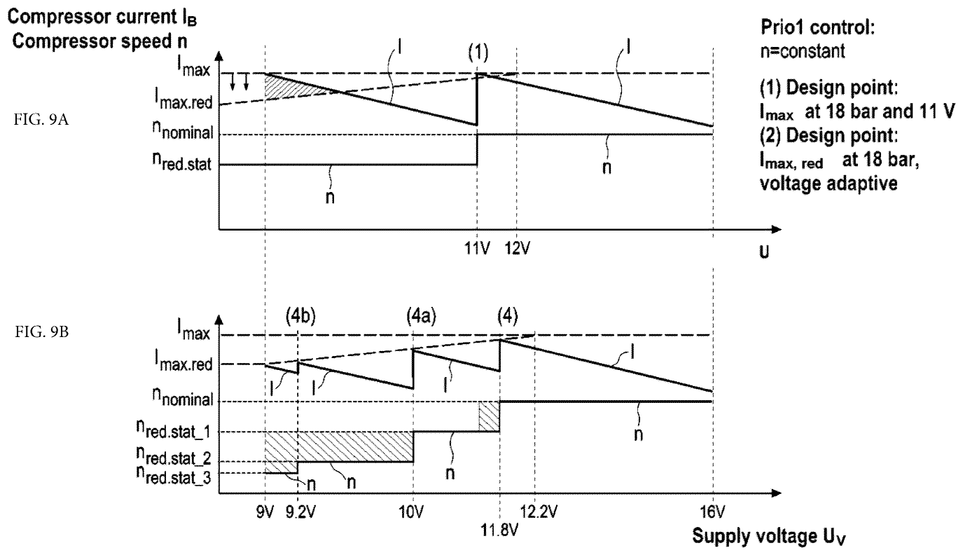

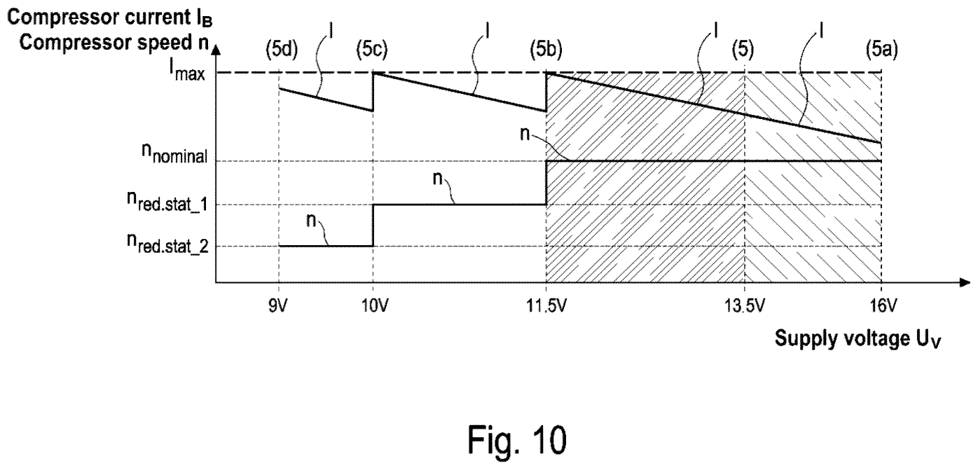

Examples of further advantageous configuration variants are shown in FIGS. 9A, 9B and 10.

In order to protect the on-board electrical system, a reduction in the maximum permissible compressor current can therefore be provided as a function of the on-board electrical system voltage, that is, a reduced motor current limit value I_{max, red} is defined as a function of the operating voltage provided by the on-board electrical system:

$${I}_{max , red} = f ( supply voltage U ) .$$

A reduction of this kind in the motor current limit value may be requested by a central vehicle controller or else implemented by a compressor controller independently. FIGS. 9A and 9B show, by way of example, a voltage-dependent, linear reduction in the permissible current from Iₘₐₓ starting at a supply voltage U=12.2 V down to a reduced motor current limit value Iₘₐₓ, red at a supply voltage U=9 V. By applying these motor current limit values, switchover voltages of 11.8 V and 10 V and 9.2 V are then obtained; see FIG. 9B.

FIG. 10 shows a further optional configuration variant: The most common voltage ranges in the vehicle, of 12 V to 13.5 V by way of example, can be handled by specifying suitable motor current limit value/target speed combinations without jumps in speed. Accordingly, the electric motor has to be configured such that it can deliver the maximum expected torque down to a supply voltage of 11.5 V without the motor current limit value being exceeded.

Furthermore, it may be advantageous, for acoustic reasons, not to get close to the maximum current limit at operating voltages above, by way of example, 13.5 V and therefore not to increase the speed accordingly, but instead to pursue the strategy of a constant speed:

FIG. 10 shows various operating ranges. In the range 5a to 5, the compressor module 10 is operated according to the “constant speed” strategy. The target speed is identical to the speed in the preferred voltage range 5 to 5b. In the range 5 to 5d, the compressor module 10 is driven according to the “target current limiting” strategy. The parameterized target speeds prevent a jump in speed within the most commonly occurring voltage ranges (5b to 5).

It is understood that the foregoing description is that of the preferred embodiments of the invention and that various changes and modifications may be made thereto without departing from the spirit and scope of the invention as defined in the appended claims.

### LIST OF REFERENCE NUMERALS

10 Compressor module
12 Compressor
14 Electric motor
14.1 Stator
14.2 Rotor
14.3 Stator coil
14.4 Hall sensor
16 Motor electronics system
18 Air dryer
20 Air distributor
30 Compressed-air supply system
32 Air spring system
34 Air springs
36 Compressed-air reservoir
38 Air dryer
40 Main pressure line
42.2 One-way valve/non-return valve
50 2/2-way valve
42 Return spring (of the 2/2-way valve 50)
44 Control solenoid (of the 2/2-way valve 50)
56 Ventilation valve
60 3/2-way valve
52 Return spring (of the 3/2-way valve 60)
54 Control piston (of the 3/2-way valve 60)
70.1, 70.2 Throttle
100 Control unit
102 Current sensor
104 Analog-to-digital converter
106 Interface

1. A compressor module comprising:
a compressor;
a speed-controlled electric motor for driving said compressor, wherein a motor current is produced during operation of said electric motor;
a motor electronics system having an electronic commutator and a speed controller assigned to said electric motor;
the compressor module being connected to or having an electronic control unit;
said electronic control unit being configured:
to specify, depending on a mean of the motor current, one of at least two different target speeds for said electric motor, wherein said at least two target speeds include at least a predefined first target speed and a predefined second target speed which is lower than said predefined first target speed; and,
to change over from specifying said predefined first target speed to specifying said predefined second target speed when the mean of the motor current reaches or exceeds a specified motor current limit value.

2. The compressor module of claim 1, wherein more than two different target speeds are specified; and, said control unit is configured to change over from specifying a predefined higher target speed to specifying the predefined lower target speed when the mean of the motor current reaches or exceeds said specified motor current limit value.

3. The compressor module of claim 1, wherein the compressor module is configured to be supplied with at least two supply voltages of different levels; said control unit is configured to specify predefined motor current limit values for each of said at least two different supply voltages; and, said motor current limit values predefined for said at least two different supply voltages are different from each other.

4. The compressor module of claim 3, wherein said control unit is configured to apply reduced motor current limit values, which are lower than a predefined maximum motor current limit value, for the at least two supply voltages, the respective voltage values of which lie below a limit voltage value.

5. The compressor module of claim 4, wherein said maximum motor current limit value is configured to be adjusted to one of at least two different, predefined maximum motor current limit values.

6. The compressor module of claim 1, wherein said electric motor includes:
an electrically commutable stator;
a permanently excited rotor; and,
said motor electronics system forms said electronic commutator, which generates an electrical rotating field for said electric motor in accordance with a specified target speed.

7. The compressor module of claim 1 further comprising:
at least one current sensor for detecting said motor current received by said electric motor;
an analog-to-digital converter for converting an output value delivered by said at least one current sensor and representing said motor current received by said electric motor into a digital signal representing said motor current received by said electric motor; and,
an interface via which said digital signal representing said motor current received by said electric motor is configured to be called up during operation.

8. The compressor module of claim 1, wherein said electric motor is configured such that said electric motor is capable of delivering a maximum expected torque down to a supply voltage of 11.5 V without said specified motor current limit value being exceeded.

9. The compressor module of claim 1, wherein the compressor module is for a compressed-air supply system of a vehicle.

10. The compressor module of claim 1, wherein said speed-controlled electric motor is a speed-controlled brushless electric motor.

11. A compressed-air supply system for a motor vehicle, the compressed-air supply system comprising:
a compressor module including a compressor, a speed-controlled electric motor for driving said compressor, wherein a motor current is produced during operation of said electric motor;
said compressor module further including a motor electronics system having an electronic commutator and a speed controller assigned to said electric motor;
said compressor module being connected to or having an electronic control unit;
said electronic control unit being configured:
to specify, depending on a mean of the motor current, one of at least two different target speeds for said electric motor, wherein said at least two target speeds include at least a predefined first target speed and a predefined second target speed which is lower than said predefined first target speed; and,
to change over from specifying said predefined first target speed to specifying said predefined second target speed when the mean of the motor current reaches or exceeds a specified motor current limit value;
at least one compressed-air consumer;
a plurality of controllable valves; and,
a compressed-air control unit for controlling said plurality of controllable valves.

12. The compressed-air supply system of claim 11, wherein said at least one compressed-air consumer is part of an air spring system or a brake system.

13. The compressed-air supply system of claim 12 further comprising a compressed-air reservoir and the compressed-air supply system being configured to be switched over between open operation and closed operation.

14. A method for operating a compressed-air supply system having a compressor and a speed-controlled electric motor for driving the compressor, the method comprising:
specifying a predefined first target speed;
regularly or continuously comparing a current value of a mean motor current received by the electric motor during operation with a predefined maximum motor current limit value;
specifying a predefined second target speed, which is lower than the predefined first target speed, as soon as the current value of the mean motor current is greater than or equal to the predefined maximum motor current limit value.
